(19) United States
(12) Patent Application Publication
(10) Pub. No.: US 2011/0081868 A1
(43) Pub. Date: Apr. 7, 2011

(54) METHOD OF REPORTING MEASUREMENT RESULT IN WIRELESS COMMUNICATION SYSTEM

(76) Inventors: Yung Mi Kim, Gyeongki-do (KR); Young Dae Lee, Gyeongki-do (KR); Sung Duck Chun, Gyeongki-do (KR); Seung June Yi, Gyeongki-do (KR); Sung Jun Park, Gyeongki-do (KR)

(21) Appl. No.: 12/673,004

(22) PCT Filed: Aug. 6, 2008
(86) PCT No.: PCT/KR2008/004553

§ 371 Date: Feb. 10, 2010

Related U.S. Application Data
(60) Provisional application No. 60/955,040, filed on Aug. 10, 2007.

(30) Foreign Application Priority Data
Aug. 10, 2007 (KR) 10-2007-0080637
Aug. 10, 2007 (KR) 10-2007-0080820

(51) Int. Cl. H04B 17/00; G08B 21/00

(52) U.S. Cl. 455/67.11; 340/540

(57) ABSTRACT

A method of reporting a measurement result includes preparing a measurement result by measuring a channel condition, identifying periodically whether the measurement result satisfies an event condition, and reporting the measurement result when the event condition is satisfied. Signaling overhead resulted from the reporting of the measurement result can be reduced.

### TECHNICAL FIELD

The present invention relates to wireless communications, and more particularly, to a method of reporting a measurement result for a channel condition in a wireless communications system.

### Background Art

Third generation partnership project (3GPP) mobile communication systems based on a wideband code division multiple access (WCDMA) radio access technology are widely spread all over the world. High-speed downlink packet access (HSDPA) that can be defined as a first evolutionary stage of WCDMA provides 3GPP with a radio access technique that is highly competitive in the mid-term future. However, since requirements and expectations of users and service providers are continuously increased and developments of competing radio access techniques are continuously in progress, new technical evolutions in 3GPP are required to secure competitiveness in the future. Reduction of cost per bit, increase of service availability, flexible use of frequency bands, simple structure and open interface, proper power consumption of a user equipment (UE), and the like are defined as requirements.

A measurement procedure provides a variety of information to support an appropriate network management and resource allocation considering a wireless environment. In general, according to a result obtained from the measurement procedure, a UE reports a measurement result for a channel condition to a base station (BS).

There are two schemes to perform the measurement procedure: event-triggered reporting and periodical reporting. In the event-triggered reporting, the UE transmits a measurement result to the BS according to a specific condition. In the periodical reporting, the UE periodically transmits the measurement result to the BS at a time set by a timer. In the two reporting schemes, the measurement result is transmitted according to a criterion, i.e., an event or a period.

However, a signaling overhead may be caused when the measurement reporting is determined simply depending on a first discriminant result. For example, when using the periodical reporting, the UE may continuously transmit the measurement result even when the BS does not require the measurement result. Unnecessary reporting may result in waste of radio resources.

In addition, a channel condition between the UE and the BS change due to various causes. Therefore, it is ineffective to perform the measurement procedure without considering such a varying channel condition.

Accordingly, there is a need for a method of performing a measurement procedure for the effective use of radio resources while reducing signaling overhead.

### DISCLOSURE OF INVENTION

### Technical Problem

The present invention provides a method of reporting a measurement result by using multiple measurement conditions.

The present invention also provides a method of reporting a measurement result by considering a channel condition.

### Technical Solution

In as aspect, a method of reporting a measurement result in a wireless communication system is provided. The method includes preparing a measurement result by measuring a channel condition, identifying periodically whether the measurement result satisfies an event condition, and reporting the measurement result when the event condition is satisfied.

In another aspect, a method of reporting a measurement result in a wireless communication system is provided. The method includes receiving a measurement control message indicating to report a measurement result by periodically identifying whether the measurement result satisfies an event condition, and transmitting a measurement report message when the measurement result satisfies the event condition, the measurement report message comprising the measurement result.

In still another aspect, a method of receiving a measurement report in a wireless communication system is provided. The method includes transmitting a measurement control message indicating a terminal to report a measurement report of a channel condition by periodically identifying an event condition, and receiving a measurement report message including information on the channel condition when the identified event condition was satisfied by the terminal.

### Advantageous Effects

Since a user equipment reports a measurement result when multiple measurement conditions are satisfied, radio resources can be effectively used while reducing signaling overhead resulted from the reporting of the measurement result.

### BRIEF DESCRIPTION OF THE DRAWINGS

FIG. 1 shows a structure of a wireless communication system

FIG. 2 is a diagram showing functional split between an evolved universal terrestrial radio access network (E-UTRAN) and an evolved packet core (EPC).

FIG. 3 is a diagram showing a radio protocol architecture for a user plane.

FIG. 4 is a diagram showing a radio protocol architecture for a control plane.

FIG. 5 shows an example of a method of reporting a measurement result according to an embodiment of the present invention.

FIG. 6 is a flow diagram showing a method of reporting a measurement result according to an embodiment of the present invention.

FIG. 7 shows an example of a method of reporting a measurement result according to another embodiment of the present invention.

FIG. 8 shows an example of a method of reporting a measurement result according to another embodiment of the present invention.

FIG. 9 is a flow diagram showing a conventional measurement procedure.

FIG. 10 is a flow diagram showing a method of transmitting a channel measurement result according to an embodiment of the present invention.

FIG. 11 is a flow diagram showing a method of reporting a measurement result according to another embodiment of the present invention.

FIG. 12 is a flow diagram showing a method of reporting a measurement result according to another embodiment of the present invention.

FIG. 13 is a flow diagram showing a method of reporting a measurement result according to another embodiment of the present invention.

FIG. 14 is a flow diagram showing a method of reporting a measurement result according to another embodiment of the present invention.

FIG. 15 is a flow diagram showing a method of reporting a measurement result according to another embodiment of the present invention.

### MODE FOR THE INVENTION

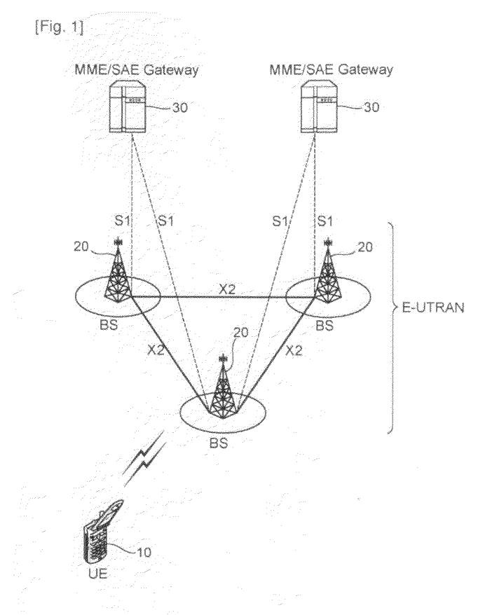

FIG. 1 shows a structure of a wireless communication system. The wireless communication system may have a network structure of an evolved-universal mobile telecommunications system (E-UMTS). The E-UMTS may be referred to as a long-term evolution (LTE) system. The wireless communication system can be widely deployed to provide a variety of communication services, such as voices, packet data, etc.

Referring to FIG. 1, an evolved-UMTS terrestrial radio access network (E-UTRAN) includes at least one base station (BS) 20 which supports a control plane protocol and a user plane protocol.

A user equipment (UE) 10 may be fixed or mobile, and may be referred to as another terminology, such as a mobile station (MS), a user terminal (UT), a subscriber station (SS), a wireless device, etc. The BS 20 is generally a fixed station that communicates with the UE 10 and may be referred to as another terminology, such as an evolved node-B (eNB), a base transceiver system (BTS), an access point, etc. There are one or more cells within the coverage of the BS 20. Interfaces for transmitting user traffic or control traffic may be used between the BSs 20. Hereinafter, downlink is defined as a communication link from the BS 20 to the UE 10, and uplink is defined as a communication link from the UE 10 to the BS 20.

The BSs 20 are interconnected by means of an X2 interface. The BSs 20 are also connected by means of an S1 interface to an evolved packet core (EPC), more specifically, to a mobility management entity (MME)/system architecture evolution (SAE) gateway 30. The S1 interface supports a many-to-many relation between the BS 20 and the MME/SAE gateway 30.

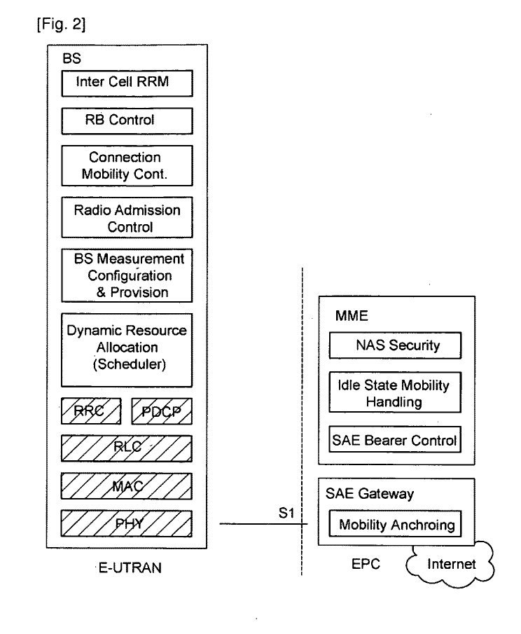

FIG. 2 is a diagram showing functional split between the E-UTRAN and the EPC.

Referring to FIG. 2, slashed boxes indicate radio interface protocol layers and white boxes indicate functional entities of the control plane.

The BS performs the following functions: (1) functions for radio resource management (RRM) such as radio bearer control, radio admission control, connection mobility control, and dynamic allocation of resources to the UE; (2) Internet protocol (IP) header compression and encryption of user data streams; (3) routing of user plane data to the SAE gateway; (4) scheduling and transmission of paging messages; (5) scheduling and transmission of broadcast information; and (6) measurement and measurement reporting configuration for mobility and scheduling.

The MME performs the following functions: (1) distribution of paging messages to the BSs; (2) security control; (3) idle state mobility control; (4) SAE bearer control; and (5) ciphering and integrity protection of non-access stratum (NAS) signaling.

The SAE gateway performs the following functions: (1) termination of a user plane packet for paging; and (2) user plane switching for the support of UE mobility.

Layers of a radio interface protocol between the UE and the network can be classified into L1 layer (a first layer), L2 layer (a second layer), and L3 layer (a third layer) based on the lower three layers of the open system interconnection (OSI) model that is well-known in the communication system. A physical layer, or simply a PHY layer, belongs to the first layer and provides an information transfer service through a physical channel. A radio resource control (RRC) layer belongs to the third layer and serves to control radio resources between the UE and the network. The UE and the network exchange RRC messages via the RRC layer.

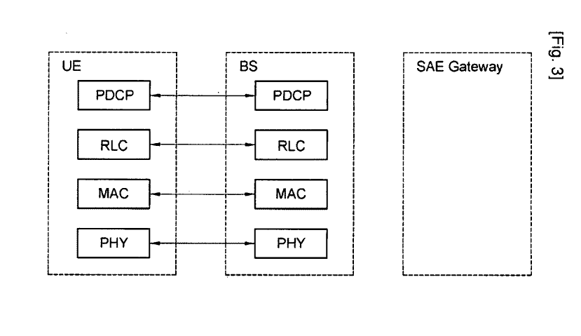

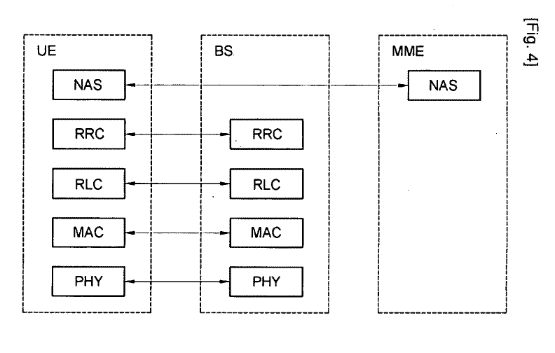

FIG. 3 is a diagram showing a radio interface protocol architecture for the user plane. FIG. 4 is a diagram showing a radio interface protocol architecture for the control plane. They illustrate an architecture of a radio interface protocol between the UE and the E-UTRAN. The user plane is a protocol stack for user data transmission. The control plane is a protocol stack for control signal transmission.

Referring to FIGS. 3 and 4, a PHY layer belongs to the first layer and provides an upper layer with an information transfer service through a physical channel. The PHY layer is coupled with a medium access control (MAC) layer, i.e., an upper layer of the PHY layer, through a transport channel. Data is transferred between the MAC layer and the PHY layer through the transport channel. Between different PHY layers (i.e., a PHY layer of a transmitter and a PHY layer of a receiver), data are transferred through the physical channel. The PHY layer can be modulated by orthogonal frequency division multiplexing (OFDM). Time and/or frequency can be utilized as radio resources.

The MAC layer belongs to the second layer and provides services to a radio link control (RLC) layer, i.e., an upper layer of the MAC layer, through a logical channel. The RLC layer in the second layer supports reliable data transmission. There are three operating modes in the RLC layer, that is, a transparent mode (TM), an unacknowledged mode (UM), and an acknowledged mode (AM) according to a data transmission method. An AM RLC provides bidirectional data transmission services and supports retransmission when the transmission of a RLC protocol data unit (PDU) fails.

A packet data convergence protocol (PDCP) layer belongs to the second layer and performs a header compression function. When transmitting an IP packet such as an TPv4 packet or an IPv6 packet, a header of the IP packet may contain relatively large and unnecessary control information. The PDCP layer reduces a header size of the IP packet so as to efficiently transmit the IP packet.

A radio resource control (RRC) layer belongs to the third layer and is defined only in the control plane. The RRC layer serves to control the logical channel, the transport channel, and the physical channel in association with configuration, re-configuration and release of radio bearers (RBs). An RB is a service provided by the second layer for data transmission between the UE and the E-UTRAN. When an RRC connection is established between an RRC layer of the UE and an RRC layer of the network, it is called that the UE is in an RRC connected mode. When the RRC connection is not established yet, it is called that the UE is in an RRC idle mode.

A non-access stratum (NAS) layer belongs to an upper layer of the RRC layer and serves to perform authentication, SAE bearer management, security control, etc.

The RRC layer defines a variety of RRC procedures in order to exchange configuration information required to manage radio resources. The RRC procedures are generally provided for configuring and controlling functions of the UE. In particular, a measurement procedure is included in the RRC procedures and provides a variety of information required to support resource allocation and a proper network management considering a wireless environment.

<Method of Reporting Measurement Result Using Multiple Conditions of Measurement Reporting>

A UE reports a measurement result after determining whether a specific condition is satisfied, instead of unconditionally reporting the channel measurement result in a periodic manner. By reporting the channel measurement result only when a first condition (i.e., a period) and a second condition (i.e., an event) are both satisfied, signaling overhead can be reduced. This is called a periodical event-triggered reporting scheme since the period and the event triggering are combined as a condition.

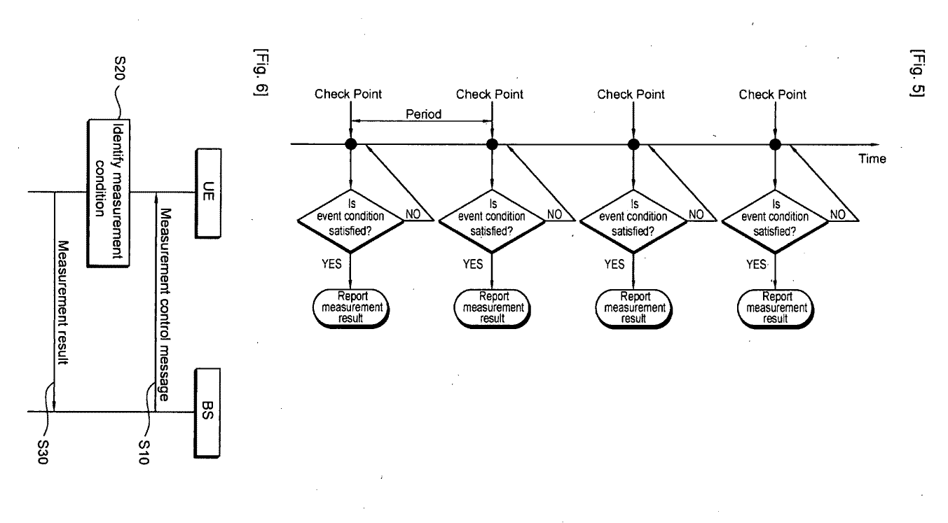

FIG. 5 shows an example of a method of reporting a measurement result according to an embodiment of the present invention.

Referring to FIG. 5, a check point denotes a time point at which a timer is expired for periodical reporting of a measurement result. The timer is reset and restarted at the check point. A UE receives an event condition from a network and determines whether the event condition is satisfied at the check point. If the event condition is satisfied, the UE reports the measurement result for a channel condition to the network. Otherwise, if the event condition is not satisfied, the UE does not deliver the measurement result but waits for a next check point.

The UE periodically determines whether the measurement result satisfies the event condition, and, if the condition is satisfied, reports the measurement result. A period for determining the event condition may vary. For example, the period may be lengthened when the channel condition is good and may be shortened when the channel condition is poor.

Examples of the event condition reported from the network to the UE may be as follows. (1) If a transmit (Tx) power level used when the UE transmits data to the network is greater than a threshold, the measurement result may be transmitted to the network. (2) If the Tx power level used when the UE transmits data to the network is less than a threshold, the measurement result may be transmitted to the network. (3) If a received signal level is less than a threshold, the measurement result may be transmitted to the network. (4) If the received signal level is greater than a threshold, the measurement result may be transmitted to the network. (5) If an interference-to-noise ratio is less than a threshold due to increase of an interference level, the measurement result may be transmitted to the network. (6) If the interference-to-noise ratio is greater than a threshold due to decrease of the interference level, the measurement result may be transmitted to the network. (7) If a bit error rate is greater than a threshold, the measurement result may be transmitted to the network. (8) If the bit error rate is less than a threshold, the measurement result may be transmitted to the network. (9) If the number of correctly decoded blocks is less than a threshold, the measurement result may be transmitted to the network. (10) If the number of correctly decoded blocks is greater than a threshold, the measurement result may be transmitted to the network. (11) If a data rate is less than a threshold, the measurement result may be transmitted to the network. (12) If the data rate is greater than a threshold, the measurement result may be transmitted to the network. (13) If a packet error rate is greater than a threshold, the measurement result may be transmitted to the network. (14) If the packet error rate is less than a threshold, the measurement result may be transmitted to the network. (15) If a latency is greater than a threshold, the measurement result may be transmitted to the network. (16) If the latency is less than a threshold, the measurement result may be transmitted to the network.

In addition, received signal levels from serving cells and neighboring cells may be compared with each other so that the comparison result is used as the event condition. (17) If any one of the neighboring cells has a received signal level less than those of the serving cells, the measurement result may be transmitted by the UE to the network. (18) If an average value of the received signal levels of the neighboring cells is greater than the received signal levels of the serving cells, the measurement result may be transmitted to the network. (19) A received signal level of any one of the neighboring cells is compared with those of the serving cells, and if a difference of the two measurement values is less than a threshold, the measurement result may be transmitted to the network. (20) An average value of received signal levels of the neighboring cells is compared with those of the serving cells, and if a difference of the two measurement values is less than a threshold, the measurement result may be transmitted to the network.

(21) If a cell having a preferred condition among the neighboring cells is modified or if the serving cells are modified, the measurement result may be transmitted to the network. (22) If a measurement result to be transmitted at a current check point is the same as that transmitted at a previous check point, the measurement result may not be transmitted. Instead, if the two measurement results are different from each other or if a difference between the two measurement results is greater than a threshold, the measurement result may be transmitted to the network. (23) A transmission time interval (TTI), which determines a semi-static attribute among constituent components of a channel, a coding rate, the number of cyclic redundancy check (CRC) bits, and rate matching are respectively compared with thresholds, and if the comparison result satisfies a requirement defined by the network, the measurement result may be transmitted to the network. In addition, if the coding rate, the number of CRC bits, etc, which are applied in a current connection condition are greater (or less) than a threshold, the measurement result may be transmitted to the network. (24) A new condition may be created by combining the aforementioned conditions, and if the new condition is satisfied, the measurement result may be transmitted to the network.

The thresholds used in the process of confirming the event condition may be reported from the network to the UE or may be predetermined.

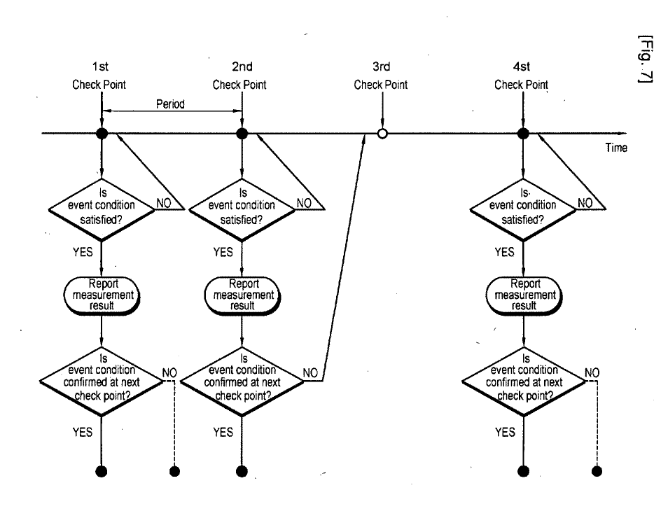

FIG. 6 is a flow diagram showing a method of reporting a measurement result according to an embodiment of the present invention.

Referring to FIG. 6, a network transmits measurement control information to a UE by using a measurement control message (step S10).

The UE identifies whether the measurement result satisfies a measurement condition after a measurement is performed (step S20). The UE evaluates a reporting criterion (i.e., periodical reporting, event-triggered reporting, and periodical event-triggered reporting) according to the measurement control information, and thus determines whether a measurement condition is satisfied.

If the measurement condition is satisfied, the measurement result is transmitted to the network (step S30).

The network transmits the measurement control information to the UE by using the measurement control message. According to the measurement control information, the UE reports the measurement result to the network according to a predetermined measurement scheme while performing the measurement procedure. The measurement control information may be transmitted to the UE through a different path according to an RRC mode of the UE. When in an RRC idle mode, the UE obtains the information by receiving a system information block (SIB) #11 transmitted through a broadcast channel (BCH). When in a CELL_FACH state, a CELL_PCH state, or a URA_PCH state, the UE may receive the measurement control information by using an SIB #12. When in a CELL_DCH state, the UE may receive the measurement control message through a dedicated control channel (DCCH).

Table 1 below shows an example of information included in the measurement control message.

TABLE 1

| Information Element | Description |
|---|---|
| 1. Message Type | type of measurement control message |
| 2. UE Information Elements | |
| 2-1. UE Transaction Identifier | transaction identification number |
| 2-2. Integrity Check Info | message authentication code, RRC |
| | message sequence number |
| 3. Measurement | |
| Information Elements | |
| 3-1. Measurement Identity | measurement identification number |
| 3-2. Measurement Command | setup/modification/release |
| 3-3. Measurement Reporting Mode | |
| 3-3-1. Measurement | RLC mode (UM RLC or AM RLC) |
| Report Transfer Mode | |
| 3-3-2. Reporting Mode | periodical reporting/event-triggered |
| | reporting/periodical event-triggered |
| | reporting |
| 3-4. Report Criteria | see Table 2 |
| 4. Physical Channel | |
| Information Elements | |
| DPCH Compressed Mode | compressed mode status information |
| Status Info | required to perform inter-frequency |
| | measurement and inter-radio access |
| | technology (RAT) measurement |

TABLE 2

| Report Criteria Info | Description |
|---|---|
| Measurement Reporting | information regarding event-triggered |
| Criteria | reporting |
| Periodical Reporting | information regarding periodical |
| Criteria | reporting |
| Amount of Reporting | number of times of reporting |
| Reporting Interval | measurement period |
| Periodical Event- | information regarding periodical event- |
| Triggered Reporting | triggered reporting |
| Criteria | |
| Amount of Reporting | number of times of reporting |
| Reporting Interval | measurement period |
| Event Identity | identifier regarding event condition |
| Triggering Condition | cell set for triggering event |
| No Reporting | no data (used when current measurement |
| | is additionally applied for another |
| | measurement) |

When a reporting mode is periodical event-triggered reporting, the measurement control information includes information regarding a measurement period and an event condition. The BS controls the measurement procedure of the UE by using the measurement control message.

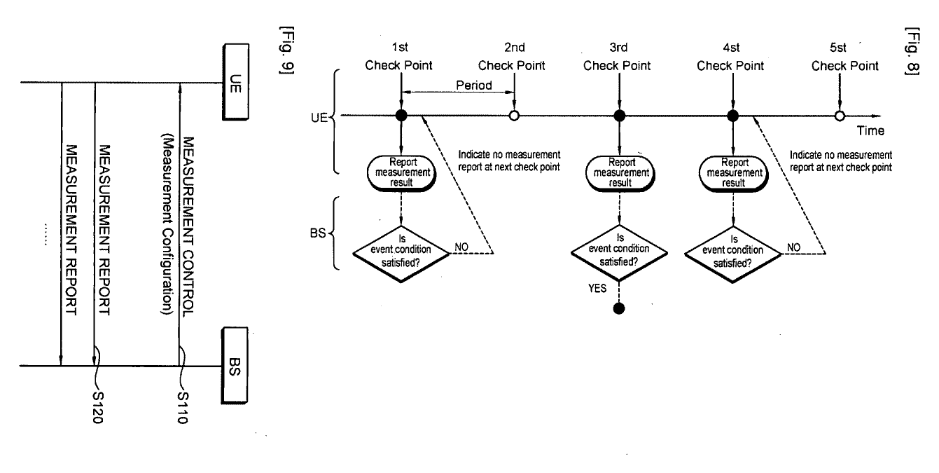

FIG. 7 shows an example of a method of reporting a measurement result according to another embodiment of the present invention. Whether a measurement result satisfies an event condition may be determined in a next check point. Whether the determination will be made in the next check point is determined in a current check point.

Referring to FIG. 7, at a 1st check point, a UE determines whether a channel condition measurement result satisfies an event condition. If the determination result shows that the event condition is satisfied, the UE reports the channel condition measurement result to a network. Then, the UE determines whether the event condition needs to be confirmed at a next check point.

If the event condition needs to be confirmed at the next check point, at a 2nd check point, the UE determines whether the event condition is satisfied by using the measurement result. If the determination result shows that the condition is satisfied, the UE reports the measurement result to the network. The UE determines whether the event condition needs to be confirmed at a next check point. In this embodiment, it is assumed that the event condition does not need to be confirmed at a 3rd check point but needs to be confirmed at a 4th check point.

Since it is determined that the event condition does not need to be confirmed at the 3rd check point, the UE does not confirm the event condition at the 3rd check point.

At the 4th check point, the UE determines whether the event condition is satisfied by using the measurement result. If the determination result shows that the event condition is not satisfied, the UE does not report the measurement report but waists for a next check point.

Such a process is effective in a case where a result of confirming a current channel condition concludes that there will be no significant change in a channel condition during a next period. For example, if a received signal level of a serving cell is greater than that of a neighboring cell by a threshold, it is determined that there is no significant cell change in the serving cell. In addition thereto, determination can be made by using the aforementioned event conditions.

If the measurement result is not reported to the network at a specific time point, the fact that the result is not reported may be informed to the network by the UE prior to the specific time point. Information indicating the fact that the measurement result is not reported may be transmitted using an RRC message, a MAC message, or a PHY layer indicator. Upon receiving the information indicating the fact that the measurement result is not reported, the network (BS) can allocate uplink radio resources of the UE to another UE, wherein the uplink radio resources are allocated for measurement result reporting of the UE. Accordingly, the radio resources can be effectively managed.

FIG. 8 shows an example of a method of reporting a measurement result according to another embodiment of the present invention. Whether the measurement result satisfies an event condition is determined by a BS.

Referring to FIG. 8, a UE prepares to report the measurement result in every measurement period. Information on the measurement period is known in advance between the UE and the BS.

At a 1st check point, the BS receives a first measurement result. Then, by using the first measurement result, the BS determines whether the measurement report is required in a next check point. It is determined that the measurement report is not required in the next check point. At a 2nd check point, the BS informs the UE that there is no need to report the measurement result. Accordingly, the UE does not transmit to the BS the measurement result of the 2nd check point.

At a 3rd check point, the UE transmits a measurement result to the BS. At the 3rd check point, the BS receives a second measurement result. Then, by using the second measurement result, the BS determines whether the measurement report is required in a next check point. If no indication is received from the BS, the UE determines that the measurement report is required.

At a 4th check point, the UE transmits a measurement result to the BS. At the 4th check point, the BS receives a third measurement result. Then, by using the third measurement result, the BS determines whether the measurement report is required in a next check point.

At a 5th check point, if the BS informs that there is no need to report a measurement result, the UE does not report the measurement result at the 5th check point.

If no indication is received from the BS, the UE reports a channel condition measurement result to the BS according to a predetermined reporting scheme. If the BS informs that there is no need to report the channel condition measurement result for a specific check point (i.e., one or a plurality of check points), the UE does not report the channel condition measurement result.

The proposed method based on the periodical event-triggered reporting scheme can be applied to a CQT reporting. A UE can report a CQI when a specific condition is satisfied in every period.

To report the measurement result to the network, the UE uses a scheme in which multiple conditions (e.g., an event and a period) are combined. By using an event having a flexible characteristic for a second discriminant, signaling overhead caused by reporting of the measurement result can be reduced, and radio resources can be effectively used.

<Method of Reporting Measurement Result Using Various Measurement Configurations>

FIG. 9 is a flow diagram showing a conventional measurement procedure.

Referring to FIG. 9, when in an RRC idle mode or an RRC connection mode, a BS reports measurement control information to a UE by using an RRC connection message and/or a measurement control message (step S110). The RRC connection message includes information required for the UE to transmit a channel quality indicator (CQI). The information includes a channel, a period, an offset at which CQI transmission starts, a retransmission number, etc. The measurement control message includes measurement configuration information (e.g., measurement parameters).

While performing the measurement procedure, according to the measurement control information, the UE transmits a measurement report message to a network when measurement reporting criteria are satisfied. The measurement report message includes a result of measurement performed by the UE.

The measurement control message includes various and detailed measurement control information. While performing the measurement procedure according to the measurement control information, the UE transmits the channel measurement result to the network by using the measurement report message when an event satisfying the measurement reporting criteria occurs or when a predetermined time elapses. Table 3 below shows an example of information included in the measurement report message.

TABLE 3

| Information Element | Description |
|---|---|
| 1. Message Type | type of measurement report message |
| 2. UE Information | |
| Elements | |
| 2.1. Integrity Check | message authentication code, RRC message |
| Info | sequence number |
| 3. Measurement | |
| Information Elements | |
| 3.1. Measurement | integer in the range of 1 to 16 |
| Identity | |
| 3.2. Measured Results | choice measurement |
| | (intra-frequency measured results list/ |
| | inter-frequency measured results list/ |
| | inter-RAT measured results list/traffic |
| | volume measured results list/quality |
| | measured results list/UE-internal |
| | measured results list/UE positioning |
| | measured results list) |
| 3.3. Measured Results | measurement result for current cell, |
| on RACH | measurement result for monitored cells on |
| | used frequency, measurement result for |
| | monitored cell on non-used frequency |
| 3.4. Additional | 1 to <MaxAdditionalMeas> |
| Measured Results | |
| 3.5. Measured Results | choice measurement |
| | (intra-frequency measured results list/ |
| | inter-frequency measured results list/ |
| | inter-RAT measured results list/traffic |
| | volume measured results list/quality |
| | measured results list/UE-internal |
| | measured results list/UE positioning |
| | measured results list) |
| 3.6. Event Results | choice event result |
| | (intra-frequency measurement event results/ |
| | inter-frequency measurement event |
| | results/inter-RAT measurement event |
| | results/traffic volume measurement event |
| | results/quality measurement event |
| | results/UE-internal measurement event |
| | results/UE positioning measurement event |
| | results |
| 3.7. Inter-RAT Cell | integer in the range of 0 to 3 |
| Info Indication | |

The measurement control information may be delivered to the UE through a different path according to an RRC state of the UE. When in an RRC idle mode, the UE obtains the information by receiving an SIB #11 transmitted through a BCH. When in a CELL_FACH state, a CELL_PCH state, or a URA_PCH state, the UE receives the measurement control information by using an SIB #12. When in a CELL_DCH state, the UE receives the measurement control message through a DCCH. Table 4 below shows an example of information included in the measurement control message.

TABLE 4

| Information Element | Description |
|---|---|
| 1. Message Type | type of measurement control message |
| 2. UE Information | |
| Elements | |
| 2.1. UE Transaction | transaction identification number |
| Identifier | |
| 2.2. Integrity Check | message authentication code, RRC message |
| Info | sequence number |
| 3. Measurement | |
| Information Elements | |
| 3.1. Measurement | used by the network as identification |
| Identity | information of a specific measurement |
| | procedure for modification and release of |
| | the measurement procedure, and used by the |
| | UE as identification information of a |
| | measurement procedure for reporting a |
| | measurement result. A total of 16 |
| | measurement procedures may exist. |
| 3.2. Measurement | indicate setup, modification, and release |
| Command | of the specific measurement procedure |
| 3.3. Measurement | indicate RLC mode (UM RLC or AM RLC) and |
| reporting Mode | reporting criteria used when reporting the |
| | measurement result |
| 3.4. CHOICE | intra-frequency measurement/inter- |
| Measurement Type | frequency measurement/inter-RAT |
| | measurement/UE positioning measurement/ |
| | traffic volume measurement/quality |
| | measurement/UE-internal measurement |
| 4. Physical Channel | |
| Information Elements | |
| 4.1. DPCH | compressed mode status information required |
| Compressed Mode | to perform inter-frequency measurement and |
| Status Info | inter-RAT measurement |

When using the aforementioned method, once the measurement configuration is determined, the UE transmits the CQI and the measurement report message with the same configuration irrespective of a current channel condition, and thus this method can be ineffective to some extent in a wireless environment where a channel condition changes are frequent. Therefore, for the effective use of radio resources, the measurement configuration needs to be flexibly selected according to a channel condition.

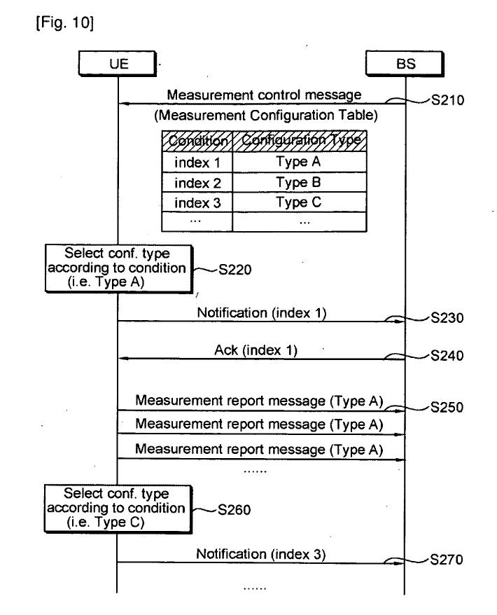

FIG. 10 is a flow diagram showing a method of transmitting a channel measurement result according to an embodiment of the present invention.

Referring to FIG. 10, a BS transmits a measurement control message including a measurement configuration table to a UE (step S210). The measurement configuration table is a table in which different measurement configuration formats are described for respective channel conditions.

Table 5 below shows an example of information for determining a channel condition.

TABLE 5

| Information Element | Description |
|---|---|
| CPICH Ec/No | ratio of noise to received signal level |
| CPICH RSCP | code reception power measured in Primary |
| | CPICH |
| Pathloss | signal loss ratio |
| carrier RSSI | entire power received by the UE (in case |
| (Received | of inter-frequency measurement) |
| Signal Strength | |
| Indication) | |
| GSM carrier RSSI | reception power measured in a GSM |
| | channel (in case of inter-RAT (GSM) |
| | measurement) |

The UE divides channel conditions into groups by using Table 5 above. For example, if a received signal level is less than a first threshold or if an interference-to-signal ratio is less than a second threshold with the increase of interference, a current channel condition has an index N (N=1, 2, 3, . . . ).

Table 6 below shows an example of information for determining measurement configurations.

TABLE 6

| Information Element | Description |
|---|---|
| Measurement Type | indicate type of a measurement procedure |
| | performed by the UE |
| | (intra-frequency measurement/inter- |
| | frequency measurement/inter-system |
| | measurement/traffic volume measurement/ |
| | quality measurement/UE-internal measurement/ |
| | UE positioning measurement) |
| Measurement Objects | the UE indicates a measurement object or |
| | information on the measurement object |
| Measurement Quantity | indicate a value to be measured for the |
| | measurement object (CPICH, Ec/No, CPICH |
| | received signal code power (RSCP), path-loss, |
| | etc) |
| Reporting Quantity | indicate a measurement value to be included |
| | when the UE reports the channel measurement |
| | result to the network |
| Measurement | provide criteria for reporting the channel |
| Reporting Criteria | measurement result from the UE to the |
| | network. Two criteria are provided, i.e., |
| | event-triggered reporting and periodical |
| | reporting. In the event-triggered reporting, |
| | the UE transmits the channel measurement |
| | result to the BS according to a specific |
| | condition. In the periodical reporting, the |
| | UE periodically transmits the channel |
| | measurement result to the BS at a time set by |
| | a timer. |
| Measurement | indicate measurement report criteria and RLC |
| Reporting Mode | mode (UM RLC or AM RLC) used when a |
| | measurement result is reported |

The UE determines a discriminant function depending on the measurement reporting criteria included in the measurement control message, and selects a measurement configuration type according to the channel condition (step S220). Examples of the measurement reporting criteria may include event-triggered reporting, periodical reporting, and other various schemes. In the event-triggered reporting, the UE transmits the channel condition measurement result to the BS according to a specific condition. In the periodical reporting, the UE periodically transmits the channel condition measurement result to the BS at a time set by a timer. In the two reporting schemes, the channel condition measurement result is transmitted according to criteria, i.e., an event or a period. In this example, a measurement configuration type A is selected.

The UE transmits to the BS a notification message indicating the selection of the measurement configuration type A (step S230). If an index of the selected measurement configuration type is an ‘index 1’, the notification message includes the ‘index 1’.

In response to the notification message, the BS transmits an acknowledgement (ACK) message for allowing the use of the received measurement configuration type (step S240). The ACK message may include the index of the measurement configuration type received by using the notification message.

The UE transmits a measurement report message whose period and format are determined according to the selected measurement configuration type (step S250).

The UE reselects a measurement configuration type according to the channel condition (step S260). In this example, a measurement configuration type C is selected.

The UE transmits to the BS a notification message indicating the selection of the measurement configuration type C (step S270). Subsequently, the BS transmits to the UE a response for the notification message. The UE transmits a measurement report message whose period and format are determined according to the selected measurement configuration type.

When the UE transmits the measurement report message or the CQI to the BS, different measurement configuration types are applied based on a channel condition and a wireless environment. The measurement configuration information includes information (e.g., reporting period) included in the measurement report message and information (e.g., a channel, a period, an offset at which CQI transmission starts, a retransmission number, etc) required to transmit the CQI.

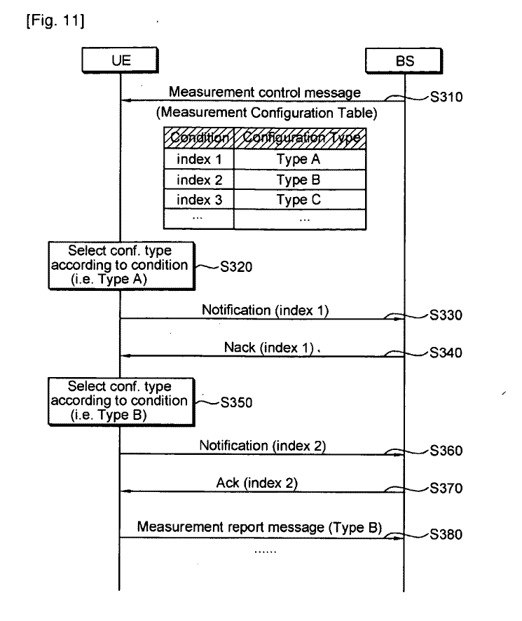

FIG. 11 is a flow diagram showing a method of reporting a measurement result according to another embodiment of the present invention.

Referring to FIG. 11, a BS transmits a measurement control message including a measurement configuration table to a UE (step S310).

The UE selects a measurement configuration type according to a channel condition (step S320). In this example, a measurement configuration type A is selected.

The UE transmits to the BS a notification message indicating the selection of the measurement configuration type A (step S330). If an index of the selected measurement configuration type is an ‘index 1’, the notification message may include the ‘index 1’.

In response to the notification message, the BS transmits a NACK message for denying the use of the received measurement configuration type (step S340). The NACK message may include the index of the channel condition received by using the notification message. That is, unlike the embodiment of FIG. 10, the BS does not allow the use of the measurement configuration type required by the UE.

Upon receiving the NACK message from the BS, the UE selects another measurement configuration type other than the denied measurement configuration type (step S350). In this example, a measurement configuration type B is selected.

The UE transmits to the BS a notification message indicating the selection of the measurement configuration type B (step S360).

In response to the notification message, the BS transmits an ACK message for allowing the use of the received measurement configuration type (step S370).

The UE transmits a measurement report message whose period and format are determined according to the selected measurement configuration type (step S380).

The BS may deny the measurement configuration type by considering the channel condition for the measurement configuration type requested by the UE or a relation with another UE. The UE receives a new measurement configuration request.

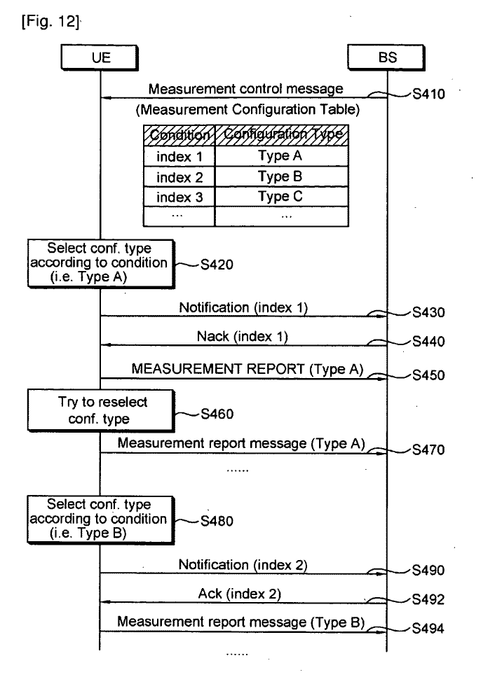

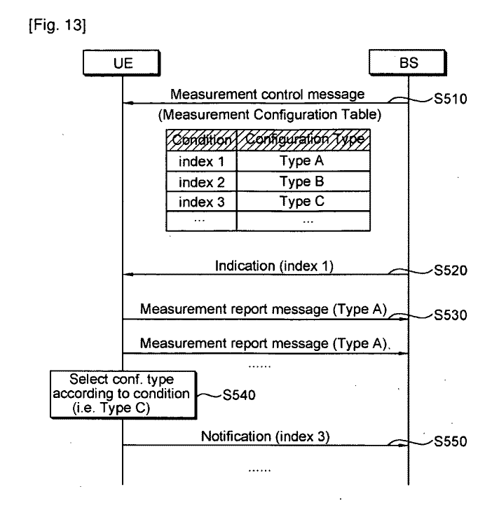

FIG. 12 is a flow diagram showing a method of reporting a measurement result according to another embodiment of the present invention.

Referring to FIG. 12, a BS transmits a measurement control message including a measurement configuration table to a UE (step S410).

The UE selects a measurement configuration type according to a channel condition (step S420). In this example, a measurement configuration type A is selected.

The UE transmits to the BS a notification message indicating the selection of the measurement configuration type A (step S430).

In response to the notification message, the BS transmits a NACK message for denying the use of the received measurement configuration type (step S440).

The UE first transmits a measurement report message according to the previously selected measurement configuration type A (step S450).

The UE selects another measurement configuration type other than the denied measurement configuration type (step S460).

If the selection of the new measurement configuration type fails, the UE transmits the measurement report message according to the previously selected measurement configuration type A (step S470).

The UE selects another measurement configuration type other than the denied measurement configuration type (step S480). In this example, a measurement configuration type B is selected.

The UE transmits to the BS a notification message indicating the selection of the measurement configuration type B (step S490).

In response to the notification message, the BS transmits an ACK message for allowing the use of the received measurement configuration type (step S492).

The UE transmits a measurement report message whose period and format are determined according to the selected measurement configuration type (step S494).

Even if a new measurement configuration type is selected, the UE can directly transmit the measurement report message according to the new measurement configuration type without using an additional notification message. Alternatively, without using the notification message and the ACK message, the UE can directly transmit the measurement report message according to the new measurement configuration type.

FIG. 13 is a flow diagram showing a method of reporting a measurement result according to another embodiment of the present invention.

Referring to FIG. 13, a BS transmits a measurement control message including a measurement configuration table to a UE (step S510).

The BS transmits to the UE an indication message indicating a measurement configuration type (step S520). That is, the measurement configuration type is selected not by the UE but by the BS. The selection result may be reported to the UE by using the indication message.

The UE transmits a measurement report message according to the indicated measurement configuration type (step S530).

The UE selects another measurement configuration type according to a channel condition (step S540). In this example, a measurement configuration type C is selected.

The UE transmits to the BS a notification message indicating the selection of the measurement configuration type C (step S550). In response to the notification message, the BS may transmit an ACK message for allowing the use of the received measurement configuration type or a NACK message for denying the use of the received measurement configuration type.

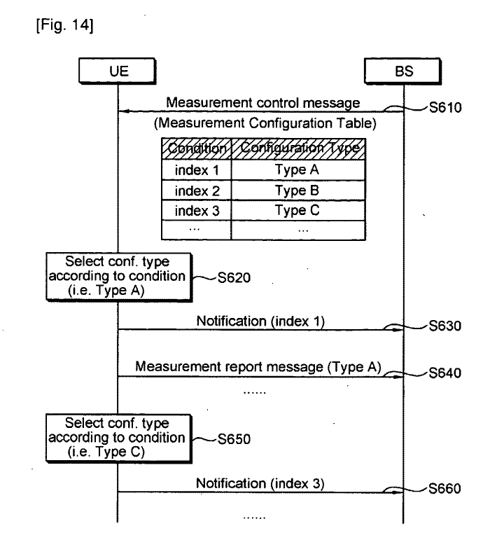

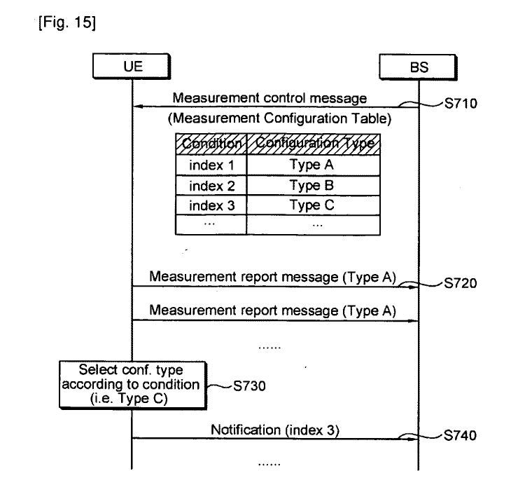

FIG. 14 is a flow diagram showing a method of reporting a measurement result according to another embodiment of the present invention.

Referring to FIG. 14, a BS transmits a measurement control message including a measurement configuration table to a UE (step S610).

The UE selects a measurement configuration type according to a channel condition (step S620). In this example, a measurement configuration type A is selected.

The UE transmits to the BS a notification message indicating the selection of the measurement configuration type A (step S630).

The UE transmits a measurement report message according to the selected measurement configuration type A (step S640). The UE directly uses the measurement configuration type selected by the UE itself instead of additionally waiting for a response for the notification message from the BS.

The UE reselects a measurement configuration type according to the channel condition (step S650). In this example, a measurement configuration type C is selected.

The UE transmits to the BS a notification message indicating the selection of the measurement configuration type C (step S660). The UE may wait for a response for the notification message from the BS or may directly use the measurement configuration type selected by the UE itself without waiting for the response.

FIG. 15 is a flow diagram showing a method of reporting a measurement result according to another embodiment of the present invention.

Referring to FIG. 15, a BS transmits a measurement control message including a measurement configuration table to a UE (step S710).

The UE transmits a measurement report message according to an initially preselected measurement configuration type (step S720). That is, the UE directly uses the pre-selected measurement configuration type without having to additionally transmit to the BS a notification message for reporting the selection of the measurement configuration type A.

The UE selects a new measurement configuration type according to a channel condition (step S730). In this example, a measurement configuration type C is selected.

If the new measurement configuration type is selected, the UE transmits to the BS a notification message indicating the selection of the measurement configuration type C (step S740). The UE may wait for a response for the notification message from the BS or may directly use the measurement configuration type selected by the UE itself without waiting for the response.

The technical features of the present invention may also apply to CQI reporting without alteration. In an initial RRC connection operation, the network transmits to the UE a CQI report table required for CQI reporting. The UE selects a CQI reporting type suitable for a channel condition from the CQI report table. Re-configuration optimized to a channel environment can be achieved by selecting the CQI reporting type suitable for the channel condition. A channel re-configuration is indicated according to the CQI reporting type irrespective of layers (i.e., an RRC layer, an MAC layer, and a PHY layer), and thus data transmission can be optimized to a wireless environment. The proposed method may be particularly effective in a cell boundary area or a place where the UE can freely move.

When the channel report message indicating a channel condition is transmitted or when the CQI is reported in a state where a connection is established between the UE and the BS, reporting configuration is determined differently according to the wireless environment. Since a measurement result for the wireless environment can be immediately used, a signaling overhead can be reduced and radio resources can be effectively used.

All functions described above may be performed by a processor such as a microprocessor, a controller, a microcontroller, and an application specific integrated circuit (ASIC) according to software or program code for performing the functions. The program code may be designed, developed, and implemented on the basis of the descriptions of the present invention, and this is well known to those skilled in the art.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of reporting a measurement result in a wireless communication system, performed by a user equipment, the method comprising:
preparing a measurement result by measuring a channel condition;
identifying periodically whether an event condition is satisfied; and
reporting the measurement result when the event condition is satisfied.

2. The method of claim 1, further comprising:
receiving information on a period for periodically identifying the event condition.

3. The method of claim 1, further comprising:
receiving information on the event condition.

4. The method of claim 1, further comprising:
identifying whether the measurement result is reported in a next period when the event condition is satisfied.

5. The method of claim 1, further comprising:
receiving an indication after reporting the measurement result, the indication indicating whether the measurement result is reported in a next period.

6. The method of claim 1, wherein the event condition triggers the reporting of the measurement result by comparing a received signal level of a serving cell and a received signal level of a neighboring cell.

7. The method of claim 1, wherein the event condition triggers the reporting of the measurement result according to a received signal level.

8-11. (canceled)

12. The method of claim 2, wherein the information on the period for periodically identifying the event condition is received through a radio resource control (RRC) message from a base station.

13. The method of claim 1, wherein the measurement result is a channel quality indicator (CQI).

14. The method of claim 1, wherein the event condition is satisfied if a received signal level of a serving cell is smaller than a received signal level of a neighboring cell.

15. The method of claim 1, wherein the event condition is satisfied if the check point at which the event condition is identified is within a plurality of transmission time intervals (TTIs) directed by a base station.

16. A user equipment for reporting a measurement result in a wireless communication system, wherein the user equipment is configured for:
preparing a measurement result by measuring a channel condition;
identifying periodically whether an event condition is satisfied; and
reporting the measurement result when the event condition is satisfied.

17. The user equipment of claim 16, wherein user equipment is further configured for receiving information on a period for periodically identifying the event condition.

18. The user equipment of claim 17, wherein the information on the period for periodically identifying the event condition is received through a radio resource control (RRC) message from a base station.

19. The user equipment of claim 16, wherein the measurement result is a channel quality indicator (CQI).
